(19) United States
(12) Patent Application Publication
(10) Pub. No.: US 2002/0046319 A1
(43) Pub. Date: Apr. 18, 2002

(54) PACKETIZED DATA INFORMATION RECORDING APPARATUS

(76) Inventor: TSUTOMU MOTOHASHI, Tokyo (JP)

Correspondence Address: DICKSTEIN SHAPIRO MORIN & OSHINSKY LLP, 2101 L STREET NW, WASHINGTON, DC, 20037-1526, US

(21) Appl. No.: 09/174,168

(22) Filed: Oct. 16, 1998

(30) Foreign Application Priority Data
Oct. 20, 1997 (JP) 9-287184

(51) Int. Cl. G06F 12/00

(52) U.S. Cl. 711/112; 710/52

(57) ABSTRACT

A control apparatus and method are disclosed for writing packet data onto an information recording medium. A next packet of data is successively written upon the completion of the writing of a preceding packet of data. The writing of the next packet of data may be conditioned on the presence of the next packet of data in a data buffer or on the presence of a quantity of data in the data buffer which exceeds a predetermined quantity of data.

### BACKGROUND OF THE INVENTION

1. Field of the Invention

The present invention relates to a writing apparatus and method for use with a writable disk drive such as a CD-R drive, a CD-RW drive, a DVD-R drive, and DVD-RAM drive which write data on an optical disk.

2. Description of the Related Art

A known technique to write data on a CD-R disc, CD-RW disc, DVD-R disc, and DVD-RAM disc is a Track At Once technique which uses a track unit for writing data. However, when the operation of reading data from a source such as a host computer is slow, a condition known as “Buffer Under Run” occurs where there is no data to write into a buffer and it is impossible to continue a writing operation.

It is impossible to write additional data on the information recording media from halfway through a track. For example, in case of write-once media like a CD-R disc, if a “Buffer Under Run” condition occurs, the track being written becomes useless.

Japanese unexamined patent publish (KOKAI) No. 7-141660, discloses an information recording apparatus which does not encounter a “Buffer Under Run” condition. It uses a packet write method of dividing data into plural packets and writing the packets, and the packet size is smaller than the buffer size.

In the packet write method, there is the variable length packet write method which divides one track into variable length packets for writing data, and the fixed length packet write method which divides one track into fixed length packets for writing the data.

However, in the conventional information recording apparatus, when writing a lot of data on an information recording media by the packet write method, it is necessary to write the data as plural packets. Therefore, disk drive operation “Over Head” like seeking a track or waiting for the proper rotation speed occurs, and it therefore takes much time to write the data.

### SUMMARY OF THE INVENTION

It is therefore an object of the present invention to provide an information recording apparatus which can reduce the time required for writing a lot of data on an information recording media using the packet write method.

In accordance with a first embodiment of the present invention an information recording apparatus is provided which can form tracks and write data on an information recording media and which starts to write a next packet of data successively at the time of finishing the writing of a previous packet of data when writing plural packets of data on tracks of the information recording media.

In accordance with a second embodiment of the present invention, an information recording apparatus is provided which, when the writing of one packet of data is finished, the writing of the next packet of data is started successively if the next packet of data is stored in a buffer, and the packet data writing operation is finished if the next packet of data is not stored in a buffer. The writing of the next packet data begins when the next packet data is stored in the buffer.

In accordance with third embodiment of the present invention, an information recording apparatus is provided which, when the writing of one packet of data is finished, the writing of next packet of data is started successively if data which exceeds a predetermined quantity is stored in a buffer, and the writing of packet data is finished if data which exceeds the predetermined quantity is not stored in the buffer. The writing of the next packet of data begins if data which exceeds the predetermined quantity is stored in the buffer.

With the first embodiment of the invention, it is unnecessary to carry out a seeking operation whenever the packet writing is finished. It is possible to carry out plural packet data writing operations successively and to reduce the time taken when a lot of data is written on the information recording media by the packet write method.

With the second embodiment of the invention, when there is not enough data in the buffer, successive data writing is not carried out. Therefore, when the reading speed from the host computer is slow or a buffer capacity is small, a “Buffer-Under-Run” condition is prevented.

With the above third embodiment of the invention, when packet size is approximately equal to the buffer size, or the packet size is more than the buffer size, a “Buffer-Under-Run” condition is prevented.

The above and other advantages and features of the invention will be more clearly understood from the following detailed description of the invention which is provided in conjunction with the following drawings.

### BRIEF DESCRIPTION OF THE DRAWINGS

FIG. 1 is a block view showing structure of an information recording apparatus of the first embodiment of the present invention.

FIG. 2 is a view showing the format of tracks and packets on the information recording media used in the information recording apparatus shown in FIG. 1.

FIG. 3 is a flow chart showing a packet writing operation for the information recording media in the information recording apparatus shown in FIG. 1.

FIG. 4 is a flow chart showing another packet writing operation for the information recording media in the information recording apparatus shown in FIG. 1.

FIG. 5 is a flow chart showing another packet writing operation for the information recording media in the information recording apparatus shown in FIG. 1.

### DETAILED DESCRIPTION OF PREFERRED EMBODIMENTS

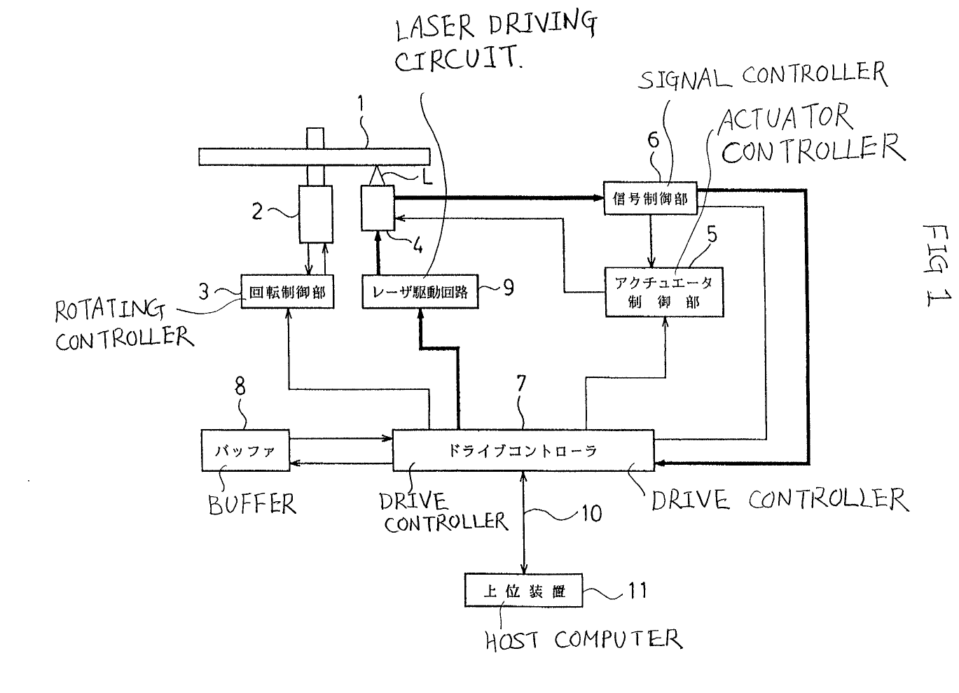

FIG. 1 is a block view showing structure of an information recording apparatus according to a first embodiment of the invention.

The information recording apparatus has a motor 2 which rotates an information recording media like a CD-R disc, CD-RW disc, DVD-R disc, and DVD-RAM disc at optimal selectable rotating speeds, and a rotating control means 3 which controls the rotating speed by changing the RPM of the motor 2.

An optical pick up 4 is provided which radiates a laser ray L on the information recording media for recording and reproducing data. An actuator controller 5 which makes the optical pick up 4 move in a radial direction of the information recording media 1, and a signal controller 6 which detects a signal from the optical pick up 4, are also provided.

A device controller 7 is provided which includes a CPU and associated memories like a ROM and a RAM with the CPU carrying out control operations. The drive controller 7 controls the entirety of the information recording apparatus, including the writing the user data in the buffer 8 and writing the user data on the track of the information recording media 1.

Buffer 8 stores the user data transferred from a host computer 11. A laser driving circuit 9 controls the laser ray of the optical pick up 4 based on command from the drive controller 7. An external interface 10 connects with the host computer 11 which controls the information recording apparatus and transmits the user data for recording to the drive controller 7.

Data recording and reproducing in the information recording apparatus shown in FIG. 1 will now be explained. When data is recorded on the information recording media 1, the drive controller 7 sets the rotating speed for the rotating controller 3. It establishes writing points on the information recording media 1 for the actuator controller 5 and transmits packet data consisting of link block data and the user data stored in the buffer 8 to the laser driving circuit 9.

The rotating controller 3 rotates the motor 2 based on a command from the drive controller 7 and makes the information recording media 1 rotate at the commanded rotating speed. The actuator controller 5 makes the pick-up 4 move to the recording position selected by the drive controller 7. The laser driving circuit 9 radiates the laser ray on recording layer of the information recording media 1 and writes the packet data transmitted from the drive controller 7.

When reproducing the packet data recorded on the information recording media 1, the laser driving circuit 9 radiates the laser ray through the optical pick-up 4, based on the output value of the drive controller 7. The signal controller 6 detects a signal response to the reflected light, transmits it to the drive controller 7 and reproduces each kind of data present on the information recording media 1.

The drive controller 7 has the functions of writing data and forming tracks on the information recording media like a CD-R disc, CD-RW disc, DVD-R disc, DVD-RAM disc. In a first embodiment of the invention, drive controller 7 starts to write data in a next packet continuously at the time of finishing the writing of data of a preceding packet when writing plural packet data on tracks of the information recording media continuously.

In a second embodiment of the invention, the drive controller 7 operates such that when the writing of data on one packet is finished, if the next packet of data is stored in the buffer, operation of writing the next packet data starts successively. On the other hand, if there is no next packet data stored in the buffer, the packet data writing operation finishes. And if next packet data is subsequently stored in the buffer, operation of writing the next packet data then starts.

In a third embodiment of the invention, the drive controller 7 operates such that when data which exceeds a predetermined data quantity is stored in the buffer when writing is finished for one data packet, the writing operation of the next packet data starts successively. On the other hand, if data stored in the buffer does not exceed the predetermined data quantity, the writing operation of packet data finishes. And if data which exceeds the predetermined data quantity is then stored in the buffer, the writing operation of the next packet data starts.

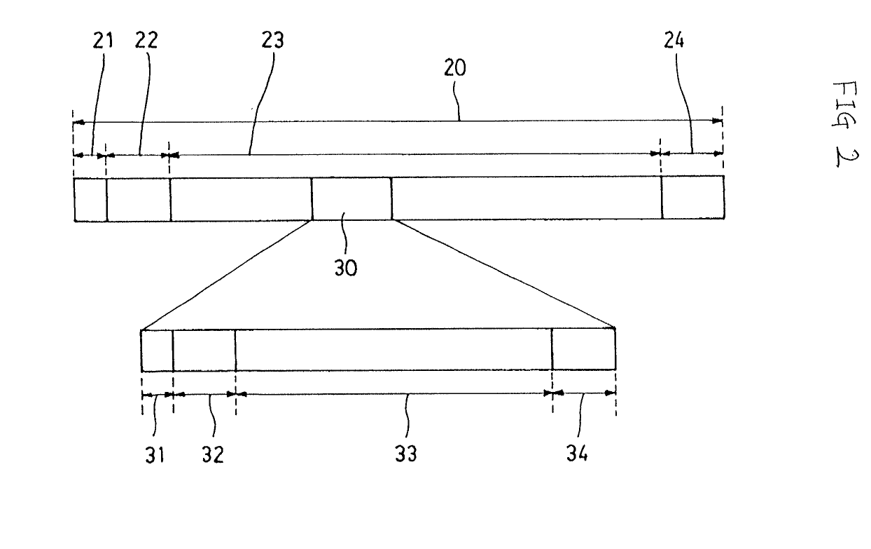

The format of track and packet on the information recording media used in the information recording apparatus will now be described with reference to FIG. 2. Plural tracks are formed on the information recording media. Each track 20 comprises a link block segment 21, a run-in block segment 22, a user data block segment 23, and a run out block segment 24. The user data block 23 can record and store plural packets 30. Each packet 30 has a link block 31, a run-in block 32, a user data block 33, and a run-out block 34. The user data block 33 is data read out from the host computer 11. The link block 31, run-in block 32, and run-out block 34 are data unrelated to the user data and are known blocks for linking packets to each other.

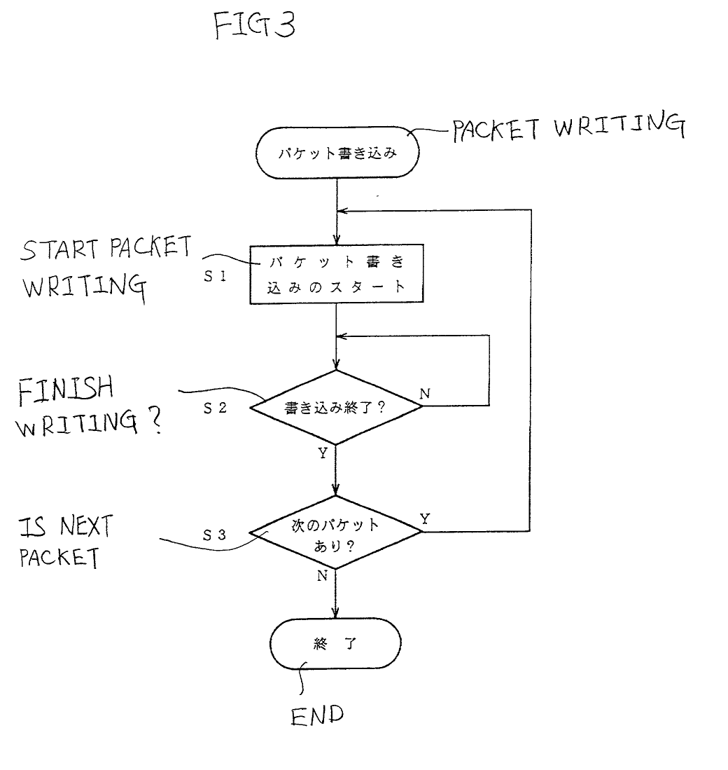

The packet writing operation for the information recording media in the information recording apparatus in accordance with the first embodiment of the invention will now be explained by the flow chart of FIG. 3.

When successively writing plural packet data on the tracks of the information recording media, this operation starts to write the first packet data in step S1, and judges if the writing is completed in step S2. If the writing operation is not completed, it continues. If the writing operation is completed, the drive controller judges if there is next packet data in step 3.

If there is a next packet data, as determined in step S3, the operation returns to step 1, and starts writing the next packet data successively to the writing of the preceding packet data. And it judges in step S2 if the packet data writing is completed. If it is not completed, the writing operation continues. If it completes, it judges if there is next packet in step S3.

In this way, the next packet writing operation starts successively at the time of finishing the writing of a previous packet of data. Therefore, it is unnecessary to carry out a seek operation when finishing the packet writing. It is possible to carry out the writing operation for plural packet data successively, and reduce the time taken when writing a lot of data on the information recording media by the packet write method.

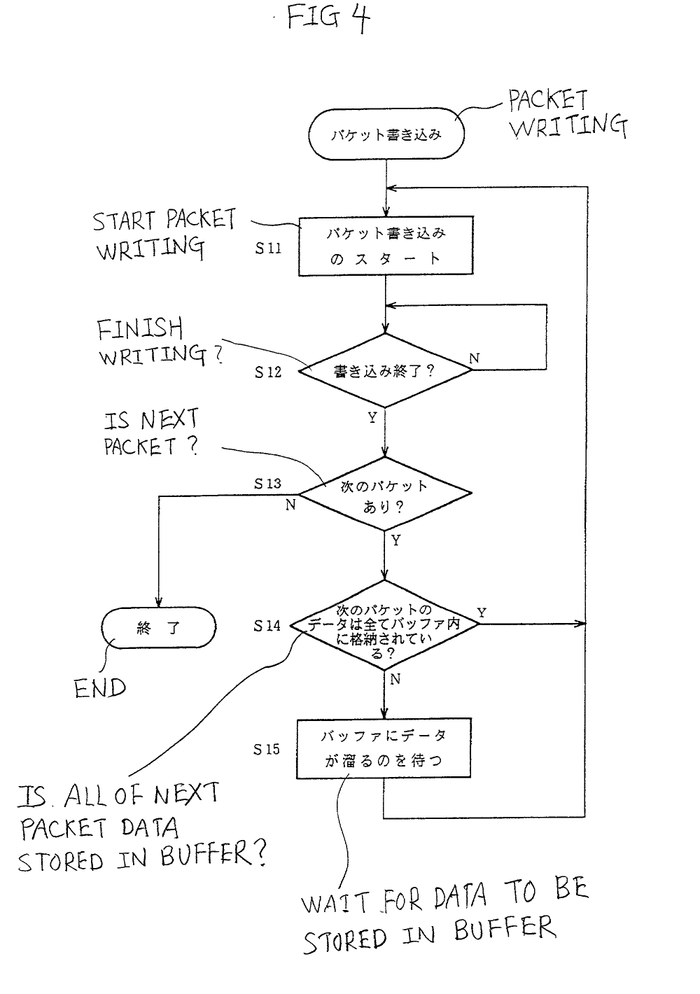

When the speed for reading out data from the host computer 11 is slow, and the capacity of the buffer 8 is small, the operation shown in FIG. 4 in accordance with a second embodiment of the invention is carried out. When writing plural packet data on a track of the information recording media successively, this operation starts writing a first packet in step S11, judges if the packet data writing is finished in step S12. If it is not finished, the writing operation continues. If it is finished, the drive controller 7 judges if there is a next packet in step S13.

If there is next packet data as determined in step S13, the drive controller 7 judges whether all of the next packet data is stored in the buffer 8 or not, in step S14. If it is stored, it returns to step S11 and starts writing next packet data successively to the previous packet data. The drive controller then judges whether the packet data writing is finished or not in step S12. If it is not finished, the packet data writing continues. If it is finished, the drive controller judges if there is next packet in step S13.

In this way, when the next packet data is stored in the buffer 8 at the time of finishing one packet data writing, the writing of the next packet data is started successively to the writing of a preceding data packet. Therefore, when the data reading speed from the host computer 11 is slow or the capacity of the buffer 8 is small, it is unnecessary to seek whenever the packet writing finishes and to carry out writing plural packet data successively.

If all of the next packet data is not stored in the buffer in step 14, the drive controller 7 stops writing data and waits until the data is stored in the buffer in step 15. When all of the next data is stored in the buffer 8, the drive controller returns to step S11 and starts to write the next packet data.

In this way, when next packet data is not stored in the buffer 8 at the time of finishing one packet data writing, the data writing operation is finished and there is no starting to write next data. When the next data is then stored in the buffer 8, the next packet data writing operation starts. Therefore, a Buffer-Under-Run condition is prevented.

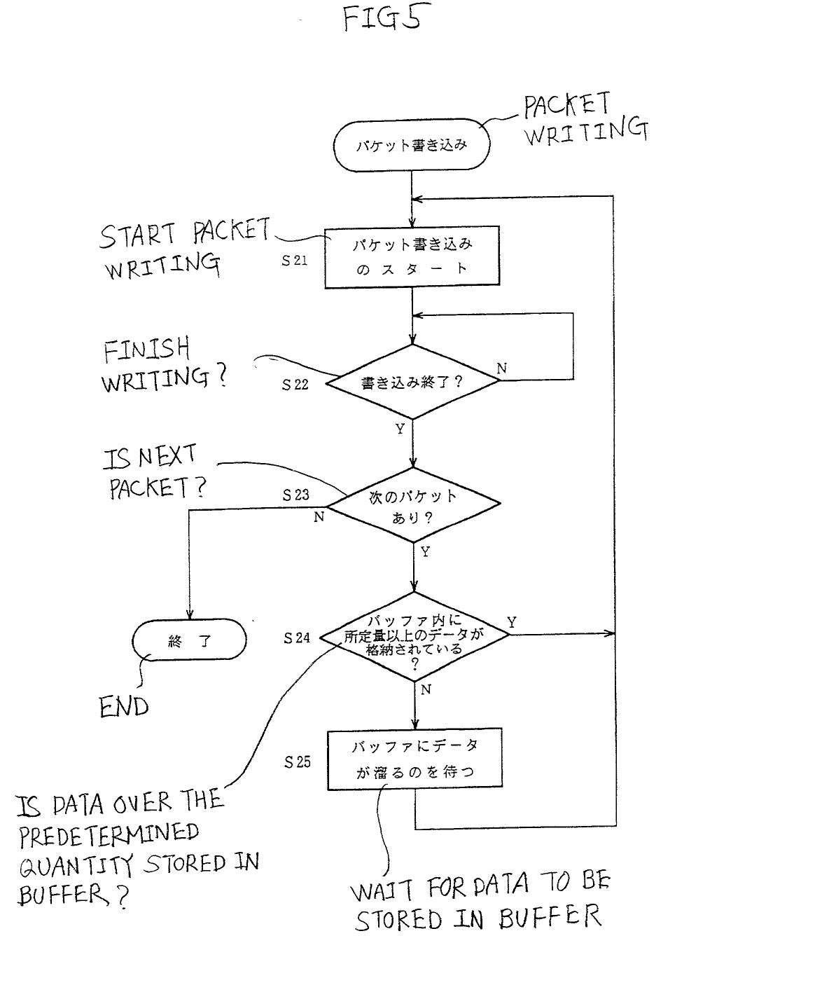

When packet size is approximately equal to the buffer size, or the packet size is more than the buffer size, namely the data quantity of one packet is equal to or more than the buffer size, the operation shown in the flow chart of FIG. 5 is carried out in accordance with a third embodiment of the invention.

When writing plural packet data on a track of the information recording media successively, this operation starts writing a first packet of data in step S21. After step S21 the drive controller 7 judges if the packet data writing is finished in step S22. And if it is not finished, the writing operation continues. If it is finished, the drive controller 7 judges if there is next packet data in step S23.

If there is a next packet data as determined in step S23, the drive controller 7 judges whether data over a predetermined quantity is stored in the buffer or not, in step S24. If so, the drive controller 7 returns to step S21 and starts writing the next packet data successively to the preceding packet data. The drive controller then judges whether the packet data writing is finished or not in step S22. If it is not finished, the packet data writing continues. If it is finished, the drive controller judges if there is next packet in step S23.

In this way, when data which exceeds a predetermined quantity is stored in the buffer 8 at the time of the writing of one packet of data is finished, the writing operation of the next packet of data starts successively. Therefore, when the one packet data quantity is equal to or more than capacity of the buffer 8, it is unnecessary to seek whenever the packet writing finishes and to carry out writing plural packet data successively.

If data over the predetermined quantity is not stored in the buffer 8 in step S24, the drive controller 7 stops writing and waits until the predetermined quantity of data is stored in the buffer in step S25. When data which exceeds the predetermined quantity is stored in the buffer, the drive controller 7 returns to step S21 and starts to write the next packet of data.

In this way, when data which exceeds the predetermined quantity is not stored in the buffer 8 at the time the writing of one packet data is finished, the data writing operation finishes and does not start to write next data. When data which exceeds the predetermined quantity is stored in the buffer 8, the next packet data writing operation starts. Therefore, a Buffer-Under-Run condition is prevented.

As mentioned above, in accordance with the above structure, it is possible to reduce the time required for writing a lot of data on an information recording media by the disclosed packet write method and apparatus of the invention.

Although specific embodiments of the invention have been illustrated and described many modifications and variations can be made without departing from the spirit and scope of the invention. As but one example, although the drive controller 7 is preferably constructed as a programmed CPU, it may be constructed as a programmable logic array, or as a hard-wired logic circuit, or any other individual or group of analog and/or digital devices capable of carrying out the functional operations described above with reference to FIGS. 3-5. Accordingly, the invention is not limited by the foregoing description but is only limited by the scope of the pending claims.

What is claimed as new and desired to be protected by Letters Patent of the United States is:

1. An information recording apparatus comprising:
a recording device for writing data in packets on tracks of an information recording media; and
a controller for operating said recording device to record plural packets of data on an information recording medium such that a next packet of data available for writing is successively written on a said information recording media at the time the writing of a preceding packet of data on said information recording medium is finished.

2. An information recording apparatus as in claim 1, further comprising a buffer memory for holding said next packet of data, said controller operating said recording device to start the writing of said next packet of data successively to the writing of said preceding packet of data if said next packet of data is present in said buffer memory, said controller operating said recording device to finish the writing of packet data if said next packet of data is not stored in said buffer memory.

3. An information recording and reproducing apparatus as in claim 2, wherein after the writing of packet data is finished said controller causes said recording device to begin writing said next packet of data when said next packet of data is present in said buffer memory.

4. An information recording apparatus as in claim 1, further comprising a buffer memory for holding said next packet of data, said controller operating said recording device to start the writing of said next packet of data successively to the writing of said preceding packet of data if a predetermined quantity of data is stored in said buffer memory, said controller operating said recording device to finish packet data writing if data in said buffer memory does not exceed said predetermined quantity.

5. An information recording apparatus as in claim 4, wherein after the writing of packet data is finished said controller causes said recording device to begin writing said next packet of data when data which exceeds said predetermined quantity is stored in said buffer memory.

6. An information recording apparatus as in claim 1, wherein said information recording media is a writable optical disk.

7. A method for recording packets of data on an information recording media comprising the steps of:
recording a first packet of data on said media;
determining if a next packet of data is available for recording;
if a next packet of data is available for recording beginning the recording said next packet of data as soon as the recording of said first packet of data is finished.

8. A method as in claim 1, wherein if said next packet of data is not available for recording, said method further comprises the stop of finishing a recording operation.

9. A method as in claim 8, wherein after a recording operation is finished, said method further comprises starting the recording of said next packet of data when said next packet of data is available for recording.

10. A method as in claim 7, wherein said determining step comprises:
determining if said next packet of data is present in a buffer memory.

11. A method as in claim 10, wherein after a recording operation is finished, said method further comprises starting the recording of said next packet of data when said next packet of data is stored in said buffer memory.

12. A method as in claim 11, wherein after a recording operation is finished, said method further comprises starting the recording of said next packet of data when said next packet of data is stored in said buffer memory.

13. A method as in claim 7, wherein said determining step comprises:
determining if at least a predetermined quantity of data to be recorded is stored in a buffer memory.

14. A method as in claim 13, wherein if said predetermined quantity of data is not present in said buffer memory, said method further comprises the step of finishing a recording operation.

15. A method as in claim 14, wherein after a recording operation is finished, said method further comprises starting the recording of said next packet of data when said predetermined quantity of data is present in said buffer memory.
